(19) United States
(12) Patent Application Publication
(10) Pub. No.: US 2002/0167567 A1
(43) Pub. Date: Nov. 14, 2002

(54) Ink jet recording head, ink jet recording apparatus, and method for manufacturing ink jet recording head

(76) Inventors: Riichi Saito, Kanagawa (JP); Toshihiro Mori, Kanagawa (JP); Naruyuki Nojo, Kanagawa (JP); Shogo Kawamura, Shizuoka (JP)

Correspondence Address: FITZPATRICK CELLA HARPER & SCINTO, 30 ROCKEFELLER PLAZA, NEW YORK, NY, 10112, US

(21) Appl. No.: 10/138,585

(22) Filed: May 6, 2002

(30) Foreign Application Priority Data
May 8, 2001 (JP) 137259/2001 (PAT.
Apr. 24, 2002 (JP) 122891/2002 (PAT.

(51) Int. Cl. B41J 2/05

(52) U.S. Cl. 347/65

(57) ABSTRACT

To electrically suitably interconnect a recording element substrate on which power supply paths are formed in a high density and an electric wiring substrate on which wiring lines for supplying power to these paths are formed, such bumps are formed and arranged on the recording element substrate at a predetermined pitch therebetween as to protrude by a predetermined amount of t1 from this substrate. On the electric wiring substrate, on the other hand, connecting terminals are formed and arranged with the same pitch as that of the bumps. Between each two of the bumps is formed an insulating film which protrudes in the protrusion direction of the bumps by a predetermined amount t2 that satisfies a relationship of t1<t2. By fitting each connecting terminal between each two of the insulating films, each connecting terminal comes in contact with corresponding each connecting terminal with a sufficient contact area provided therebetween without giving rise to short-circuiting or open-circuiting.

### BACKGROUND OF THE INVENTION

1. Field of the Invention

The present invention relates to an ink jet recording head, an ink jet recording apparatus, and a method for manufacturing the ink jet recording head and, more particularly to, a construction of a connecting section between a recording element substrate (liquid discharging substrate) on which a recording element (energy generating means) and a wiring substrate for supplying power thereto.

2. Related Background Art

An ink jet recording apparatus, a so-called non-impact recording type recording apparatus, refers to an apparatus for recording information by discharging recording liquid (ink) to a subject medium. This type of ink jet recording apparatus has excellent features such as that it can record information fast, that it can use a variety of recording media as the subject medium in recording, and that it will not give little noise during recording. These features of the ink jet recording apparatus qualify itself for wide use as a printer or an apparatus equipped with a recording mechanism such as a word processor, a facsimile, a copy machine, etc.

Typically this type of ink jet recording apparatus comprises: an ink jet recording head including a plurality of ink jet recording nozzles each having an discharge port for discharging liquid drip and a recording element for generating energy to discharge the liquid drip; and a liquid supply system for supplying liquid to the ink jet recording head. There are two types of the ink jet recording head; one type (edge shooter type) of discharging recording liquid in parallel with a substrate on which the recording elements are arrayed and the other type (side shooter type) of discharging the recording liquid perpendicularly to a substrate on which electric thermal converting elements are arrayed.

The ink jet recording type typically employs a method for using an electric thermal converting element as the recording element. By this method, thermal energy is given to liquid to utilize a pressure of bubbles produced when the liquid subsequently changes in phase to foam (boil) in order to discharge drip of the recording liquid. An ink jet recording apparatus employing such a recording method specifically supplies as a recording signal an electric pulse to an electric thermal converting element, which in turn generates thermal energy to bring about film boiling of the liquid in order to generate a pressure correspondingly, which pressure causes minute drip of the liquid to be discharged from a minute ejection outlet, thus recording information on a subject medium.

FIG. 14 shows a recording element substrate 101 constituting an important section of a side shooter type ink jet recording head that has been used conventionally. The figure is a partially exploded perspective view.

The recording element substrate 101 comprises a substrate 102 and a member 123 that constitutes electric wiring and a liquid chamber filled with ink which are formed on the board 102 by film forming technologies. The substrate 102 is made of silicon formed to a thickness of, for example, 0.5 to 1.0 mm. In the substrate 102 is formed a plurality of ink supply outlets 103 each consisting of an elongated groove shape through-outlet for receiving liquid into the liquid chamber from the outside. On both the sides of each of the ink supply outlets 103 on the substrate 102 is arrayed each row of electric thermal converting elements 104 staggeringly.

The liquid chamber is formed so that it may communicate with each of the ink supply outlets 103 and also that it may enclose the electric thermal converting elements 104 formed on both the sides of each ink supply outlet 103. In the liquid chamber is formed an ink flow path wall 107 constituting an ink flow path running through a position above each electric thermal converting element 104 and is formed also an ejection outlet 108 above each electric thermal converting element 104.

Furthermore, on the substrate 102 is formed an electric wiring line (not shown) made of Aluminum (Al) for supplying power to each of the electric thermal converting elements 104, which wiring line is connected to an electrode section 105 connected to an external power supply. The electrode section 105 is provided roughly at each of two longitudinal ends on the substrate 102, having a plurality of arrayed connecting members 106 called a bump made of gold (Au).

However, an ink jet recording head using the above-mentioned recording element substrate 101 has the following problems.

### SUMMARY OF THE INVENTION

In the improvements in the number of colors and the picture quality of a recorded image represented by a recent photo-grade, the ink jet recording head has been designed to have a larger number of nozzles and a smaller pitch between the nozzles. With this, therefore, the electric thermal converting elements formed on the recording element substrate have also been devised to be more numerous and less spaced from each other. Besides, with improving functions of the electric thermal converting elements, the bumps 106 of the electrode section 105 have also been devised to be more numerous and less spaced from each other. This has brought about a larger risk of poor connection such as open-circuiting or short-circuiting occurring between each bump 106 and a connecting terminal of an electric wiring line connected to an external power supply when they are connected with each other, thus leading to a significant problem of a necessity to improve the packaging yield and the packaging reliability.

Furthermore, with the improvements in the number of colors and the picture quality, the number of the nozzles hence the number of the electric thermal converting elements on the recording element substrate has been increased, thus increasing the power supplied to the electric thermal converter. This has brought about one problem of a necessity to suppress the connection resistance between the recording element substrate and the electric wiring substrate.

Furthermore, a higher density of the electric thermal converters hence that of the electric wiring lines has been one factor of increasing the costs of the ink jet recording head. To solve these problems, it is desired to improve the packaging yield and reliability and reduce the connection resistance without increasing the costs significantly.

The present invention is devised taking into account the above-mentioned problems of the conventional technologies. It is, therefore, an object of the present invention to provide an ink jet recording head having such a recording element substrate on which power supplying paths are formed densely and electric wiring for connecting the recording element substrate to an external device as being able to prevent poor connection such as open-circuiting or short-circuiting from occurring between the recording element substrate and a connecting terminal of the electric wiring to thereby improve the packaging yield and reliability and also reduce the connection resistance when the recording element substrate and the electric wiring are connected with each other. It is another object of the present invention to provide such an ink jet recording head without increasing the manufacturing costs significantly.

To this end, an ink jet recording head according to the present invention comprises:

a liquid discharging substrate provided with both of a plurality of energy generating elements for generating energy utilized to discharge liquid from each of a plurality of ejection outlets in response to an electric signal and a plurality of connecting members electrically connected to said plurality of energy generating elements; and

an electric wiring substrate having a plurality of connecting terminals connected to said plurality of connecting members for transmitting an electric signal supplied from the outside to said plurality of energy generating elements, wherein:

said plurality of connecting members protrudes by a predetermined protrusion amount from said liquid discharging substrate;

said liquid discharging substrate has, between said plurality of connecting members, an insulating member comprised of at least one member protruding in the same direction as said plurality of connecting members; and

the protrusion amount of said insulating members is larger than an amount of the protrusion of said plurality of connecting members.

By this configuration, it is possible to fit each of said plurality of connecting terminals between each two of said plurality of connecting members so that said each of said plurality of connecting terminals may come in contact with each of said plurality of connecting members when said liquid discharging substrate and said electric wiring substrate are fixed to each other, so that said each of said plurality of connecting terminal and said each of said plurality of connecting members can come in good contact with each other with a sufficient contact area provided therebetween without short-circuiting or open-circuiting.

Preferably, the insulating member placed between each two of said plurality of connecting members is formed of the same material as the liquid chamber filled with liquid and in the same process as that for forming the liquid chamber in a step for forming the member of the liquid chamber on the liquid discharging substrate, especially, by photolithography. It is thus possible to form the insulating members with little increase in the manufacturing costs. Moreover, if the liquid chamber is comprised of an orifice member and a partition member, preferably the insulating member placed between each two connecting members is formed of the same material as the partition member and in the same process as that for forming the partition member, especially, by photolithography.

In the ink jet recording head of the present invention, preferably, any of the following methods is employed in order to electrically interconnecting each connecting member and each connecting terminal suitably with a suppressed contact resistance therebetween.

One method comprises the steps of:

filling a gap between a liquid discharging substrate and an electric wiring substrate with thermo-hardening adhesive agent around connecting terminals of each connecting member and each connecting terminal in a state where said each connecting member and said each connecting terminal are arranged on said liquid discharging substrate and said electric wiring substrate respectively in such a manner as to be in contact with each other; and

heating and thereby hardening said thermo-hardening adhesive agent as applying a pressure across said liquid discharging substrate and said electric wiring substrate in such a direction as to press said connecting member and said connecting terminal to each other.

In this case, preferably the thermo-hardening adhesive agent is an anisotropic conductive one containing conductive particulate because it is suitable for high-density packaging.

Another method involves gang bonding by means of under-pressure heating on the connecting member and the connecting terminal. A further method involves single-point bonding by means of supersonic load on each connecting member and each connecting terminal.

An ink jet recording apparatus according to the present invention comprises the above-mentioned ink jet recording head mounted thereon. This ink jet recording apparatus can suitably supply power with a low resistance to energy generating means equipped to the ink jet recording element and so can suitably drive each of the energy generating means to thereby record an image with a high picture quality.

An ink jet recording head manufacturing method according to the present invention comprises the steps of:

forming on a liquid discharging substrate a plurality of energy generating elements for generating energy utilized to discharge liquid from a discharge port in response to an electric signal;

forming on said liquid discharging substrate a plurality of connecting members which is connected to said energy generating elements and which protrudes by a predetermined protrusion amount from a surface of said liquid discharging substrate;

forming, between each two of said plurality of connecting members on said liquid discharging substrate, each of a plurality of insulating members each comprised of at least one member protruding more than said predetermined protrusion amount in the same direction as said plurality of connecting members;

fitting each of said plurality of connecting terminals provided on an electric wiring substrate connected with said plurality of connecting members between each two of said insulating members so that said each connecting terminal and said each connecting member may come in contact with each other in order to transmit an electric signal supplied from the outside to said energy generating elements; and

fixing said liquid discharging substrate and said electric wiring substrate to each other at a position where said each connecting member and said each connecting terminal of said electric wiring substrate come in contact with each other.

### BRIEF DESCRIPTION OF THE DRAWINGS

FIG. 1 is a partially exploded perspective view for showing a recording element substrate according to a first embodiment of the present invention;

FIG. 2 is an exploded perspective view for showing a recording element unit in which the recording element substrate of FIG. 1 is incorporated;

FIG. 3A is a cross-sectional view for showing a connecting section between the recording element substrate and an electric wiring substrate of the first embodiment of the present invention and FIGS. 3B, 3C and 3D are cross-sectional views for showing a connecting section of a conventional example;

FIG. 4 is a cross-sectional view for showing the connecting section of a connection example of the first embodiment of the present invention;

FIG. 5 is a cross-sectional view for showing the connecting section of another connection example of the first embodiment of the present invention;

FIG. 6 is a flowchart for showing steps for manufacturing the recording element substrate unit according to the first embodiment of the present invention;

FIG. 7 is an expanded view for showing an important part of an example of the first embodiment of the present invention in which a liquid chamber is comprised of an orifice member and a partition member;

FIG. 8A is a top view for showing important parts of the recording element substrate and the electric wiring substrate before being connected to each other according to a first example of a second embodiment of the present invention and FIG. 8B is a cross-sectional view taken along line 8B-8B of FIG. 8A;

FIG. 9 is a top view for showing the important parts of the recording element substrate and the electric wiring substrate after being connected to each other according to the first example of the second embodiment of the present invention;

FIG. 10A is a top view for showing important parts of the recording element substrate and the electric wiring substrate before being connected to each other according to a second example of the second embodiment of the present invention and FIG. 10B is a cross-sectional view taken along line 10B-10B of FIG. 10A;

FIG. 11 is a top view for showing the important parts of the recording element substrate and the electric wiring substrate after being connected to each other according to the second example of the second embodiment of the present invention;

FIG. 12 a cross-sectional view for showing the connecting section of a connection example according to the second embodiment of the present invention;

FIG. 13 is a perspective view for showing an ink jet recording apparatus according to the present invention;

FIG. 14 is a partially exploded perspective view for showing a conventional recording element substrate; and

FIG. 15 is a top view for showing important parts of the conventional recording element substrate and electric wiring substrate after being connected with each other.

### DESCRIPTION OF THE PREFERRED EMBODIMENTS

The following will describe preferred embodiments of the present invention with reference to the drawings.

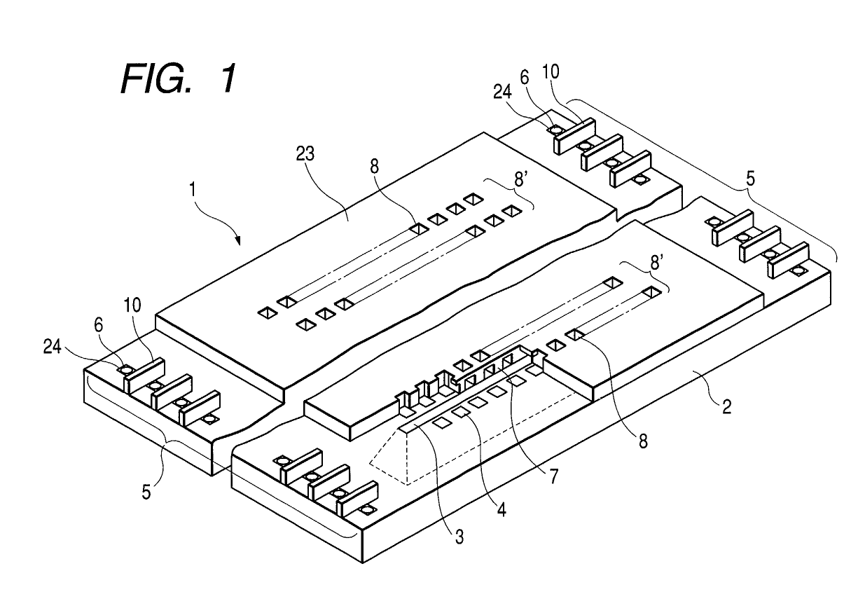

FIG. 1 is a perspective view for showing a recording element substrate (liquid discharging substrate) 1 which constitutes an ink jet recording head according to this embodiment, as partially exploded to explain its configuration.

A recording element substrate 1 comprises a substrate 2 and electric wiring, a member 23 constituting a liquid chamber filled with ink, etc. which are formed on the substrate 2. The substrate 2 is made of Si formed to a thickness of, for example, 0.5 to 1.0 mm. In the substrate 2 is formed a plurality of ink supply outlets each consisting of a long groove shaped through-outlet for receiving liquid in the liquid chamber from the outside. On both the sides of each of the ink supply outlets is arrayed one row of electric thermal converting elements (energy generating means) 4.

The liquid chamber is formed in such a manner as to communicate with each ink supply outlet 3 and also to enclose the electric thermal converting elements formed on both the sides of each ink supply outlet 3. In the liquid chamber is formed an ink flow path wall 7 which constitutes an ink flow path running from the ink supply outlet to a position above each electric thermal converting element 4 and has an discharge port 8 formed therein at a corresponding position above each electric thermal converting element 4.

Furthermore, on the substrate 2 is formed an electric wiring line made of Al etc. for supplying power to each electric thermal converting element 4, which wiring line is connected to an electrode section 5 connected to an external power supply source. The electrode section 105 is provided nearly at both longitudinal ends of the substrate 102 thereon and has a plurality of electrode pads 24 formed thereon arranged with a predetermined pitch therebetween, on each of which electrode pads is formed a connecting member 6 called a bump made of Au etc. Between each two of the bump 6 is formed an insulating member 10 which protrudes from the formation surface of the bump 6 in the same direction as the bump 6 does. Although the insulating member 10 is shown in FIG. 1 to be a rectangular prism in shape, it may be a cylinder, a cone, or any other similar shape to obtain the same effects.

Utilizing the crystal orientation of the substrate 2, the ink supply outlet 3 is formed by anisotropic etching in such a manner as to extend from the formation surface of the electric thermal converting element 4 widely to its opposite side surface. If the substrate 2 has, for example, a wafer surface-directional crystal orientation of <100> and a thickness-directional crystal orientation of <111> and when anisotropic etching is conducted on an alkali-based substance (KOH, TMAH, hydrazine, etc.), the etching proceeds at an angle of about 54.7 degrees. By this method, the ink supply outlet 3 can be formed to have a desired depth and a desired widening angle. Moreover, a member 23 that constitutes the liquid chamber is comprised of a construction film made of an epoxy-based material formed in a predetermined pattern by photolithography.

This recording element substrate 1 utilizes the electric thermal converting element 4 to generate an air bubble in ink supplied through an ink flow path 9 to thereby eject the ink through the discharge port 8. The recording element substrate 1 is combined with an ink supply system for supplying ink thereto and a member connected to an electrical system for supplying power thereto to thereby constitute a recording element unit, a plurality of which units is combined as necessary to thereby constitute an ink jet recording head of this embodiment.

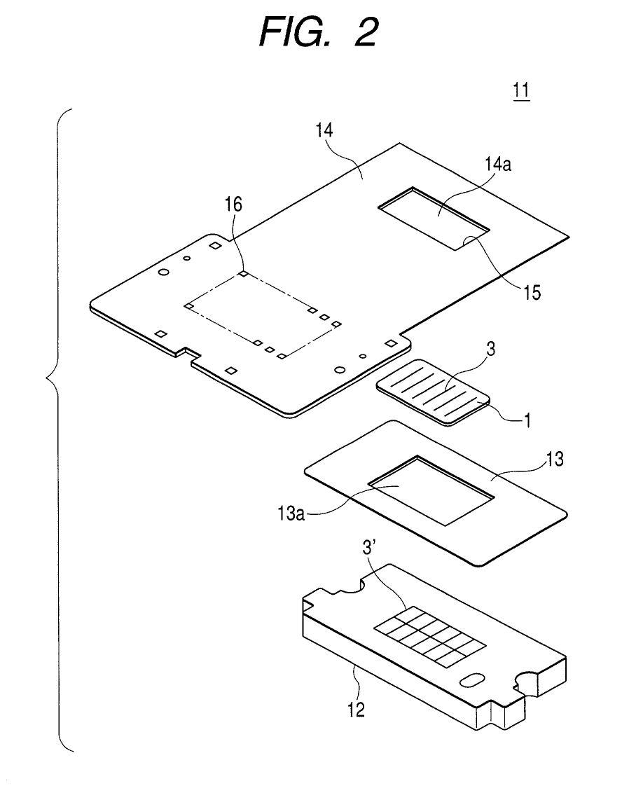

FIG. 2 shows an exploded perspective view of the recording element unit 11 of this embodiment. This recording element 11 is given by joining the recording element substrate 1, a second plate 12, a second plate 13, and an electric wiring substrate 14.

The first plate 12 has a plurality of ink supply outlets 3′ formed therein at such a position as to be connectable to the ink supply outlets 3 formed in the recording element substrate 1. The recording element substrate 1 is adhered and fixed onto the first plate 12 at such a high accuracy in positioning that the ink supply outlets 3 and 3′ may be interconnected with the ink supply outlet 3 facing the first plate 12. This first plate 12 has a thickness of, for example, 0.5 to 10.0 mm.

The second plate 13 has an opening 13a formed therein, which is larger than an external size of the recording element substrate 1. The second plate 13 is adhered and fixed onto the first plate 12 in such positioning that the recording element substrate 1 may be placed in the opening 13a.

The electric wiring substrate 14 is a member for transmitting to the recording element substrate 1 an electric signal for discharging ink. Near one end of the electric wiring substrate 14 is formed an opening 14a for exposing the discharge port 8 formed in the recording element substrate 1, while near the other end and on the right side surface thereof is formed a plurality of external signal input terminals 16 arranged in a predetermined pattern to be connected to an external signal supply source. Near an edge of the opening 14a and on the side surface opposite to the formation side surface of the external signal input terminal 16 is formed a plurality of connecting terminals 15 with the same pitch therebetween as that of the bumps 6 formed in the recording element substrate 1. The electric wiring substrate 14 has wiring, not shown, for interconnecting each of the external signal input terminals 16 and each of the connecting terminals 15.

The electric wiring substrate 14 is adhered and fixed onto the second substrate 13 as positioned in such a manner that each of the connecting terminals 15 may be connected to each of the bumps 6 on the recording element substrate 1. The second plate 13 has roughly the same thickness as the substrate 2 so that in this joining of the electric wiring substrate 14 the connecting terminal 15 and the corresponding bump 6 may be electrically interconnected in a plane without giving rise to unnecessary stress in the joining direction at the interconnecting section and its surroundings. The thickness of this second plate is, for example, 0.5 to 1.0 mm approximately.

The first plate 12 and the second plate 13 are made of alumina (Al₂O₃) in this embodiment. Although the material of the first and second plates 12 and 13 is not limited to alumina, preferably the material of these plates has roughly the same linear expansion coefficient and at least roughly the same heat transfer rate as those of the material of the recording element substrate 1. The preferably material includes, for example, silicon (Si), aluminum nitride (AlN), zirconium, silicon nitride (Si₃N₄), silicon carbonate (SiC), molybdenum (Mo), and tungsten (W).

An ink jet recording head comprised of such a recording element unit 11 is incorporated in, for example, an ink tank holder for holding detachably an ink tank storing ink therein. In this case, an ink supply path formed in contact with a supply outlet in the ink tank is connected to the ink tank holder at an opening formed in the back side surface opposite to the surface to which is joined the recording element substrate 1 of the ink supply outlet 3′ of the first plate 12. Then, the ink stored in the ink tank is supplied through the ink supply outlet 3 and 3′ into the liquid chamber formed on the recording element substrate 1.

This ink tank holder is mounted, for example, on the carriage of the ink jet recording apparatus, in which case the external input signal terminal 16 is abutted against the electrical terminal on the side of the body of the recording apparatus to be electrically connected to an electrical system of that body of the recording apparatus. The ink jet recording apparatus selectively applies an electric pulse through the external signal input terminal 16 to the electric thermal converting element 4 at a predetermined timing while reciprocating the carriage and also carrying a subject medium to thereby change the relative positional relationship between the ink jet recording head and the subject medium, thus discharging ink through the ink jet recording head to record information.

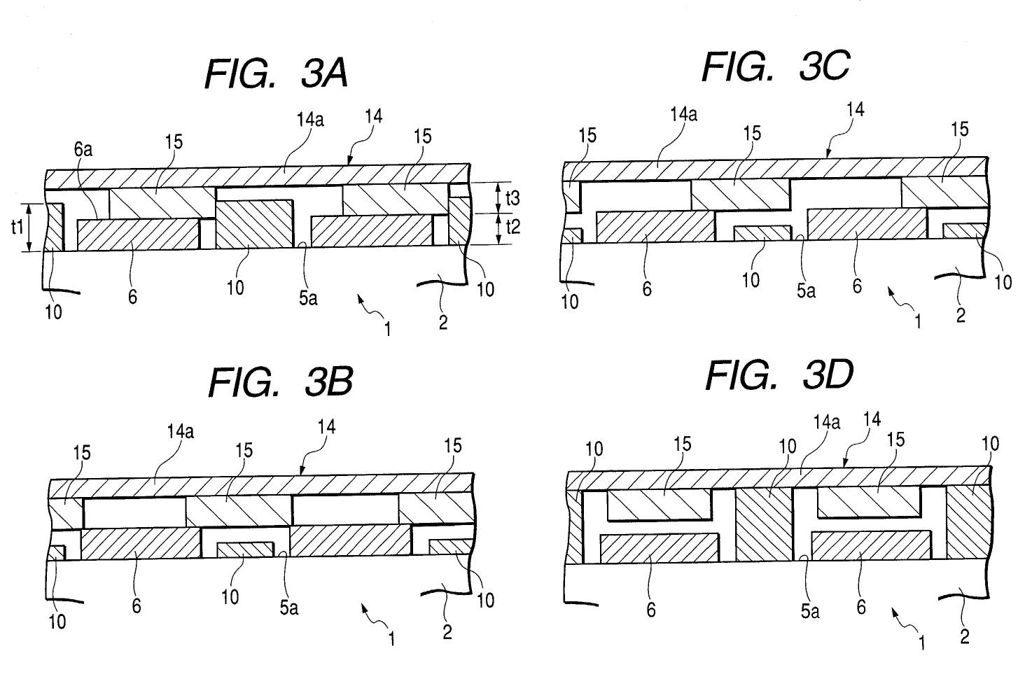

The following will describe in more detail a construction of the connecting section between the recording element substrate 1 and the electric wiring substrate 14 with reference to FIGS. 3A to 3D. FIGS. 3A to 3D are schematic cross-sectional views for showing the connecting section between the recording element substrate 1 and the electric wiring substrate 14.

As mentioned above, the electrode section 5 of the recording element substrate 1 of this embodiment has the insulating film (insulating member) 10 formed thereon. As shown in FIG. 3A, the thickness of this insulating film 10 is larger than that of the bump 6 and smaller than a total sum of the thickness of the bump 6 and that of the connecting terminal 15. That is, supposing the thickness of the insulating film 10 to be t1, that of the bump 6 to be t2, and that of the connecting terminal 15 to be t3, a relationship of (t2<t1<t2+t3) is established. Note here that although the bump 6 is shown in FIGS. 3A to 3D to be flat on its right side surface, it may generally be of any other shape and also that the thickness of the bump 6 refers more strictly to a distance from a top 6a of the bump 6 to a surface 5a of the electrode section 5.

The insulating film 10 having such a configuration is provided to the ink jet recording head of this embodiment, to enable preventing short-circuiting or open-circuiting from occurring at the intersection of the bump 6 and the connecting terminal 15. This is described with reference to FIGS. 3B, 3C, and 3D showing cross-sectional views of the connecting section of a comparison example of this embodiment.

Although the electric wiring substrate 14 is joined in such positioning that each of the bumps 6 and the corresponding each of the connecting terminals 15 may be abutted against each other as mentioned above, it may have some shift. This shift may have a significant influence especially if the bumps 6 and the connecting terminals 15 are formed with a narrow pitch therebetween.

To guard against this, if the insulating film 10 is not provided or thinner than the bump 6, the connecting terminal 15 may come in contact with the adjacent bumps 6 on both the sides thereof to give rise to short-circuiting as shown in FIG. 3B. Moreover, even if it may not come in contact with them to such an extent as to give rise to short-circuiting, as shown in FIG. 3C the bump 6 and the connecting terminal 15 may be separated from each other greatly to decrease the connecting area therebetween, thus increasing the connecting resistance.

According to this embodiment, on the other hand, each connecting terminal 15 can be fitted between each two of the insulating films 10 to suppress the shift down to a predetermined amount or less, thus electrically interconnecting each bump 6 and the corresponding each connecting terminal 15.

In a case where, according to this embodiment, the electric wiring substrate 14 overlaps such a section of the recording element substrate 1 that has the bumps 6 and the insulating films 10 formed thereon to thereby interconnect the connecting terminal 15 and the bump 6, if the thickness of the insulating film 10 is larger than a total sum of the thickness of bump 6 and that of the connecting terminal 15, as shown in FIG. 3D the bump 6 and the connecting terminal 15 do not come in contact with each other, thus giving rise to open circuiting therebetween in some cases. To guard against this, the thickness of the insulating film 10 is set smaller than a total sum of the thickness of the bump 6 and that of the connecting terminal 15.

This embodiment thus makes it possible to position the bump 6 and the connecting terminal 15 at a high accuracy by using such a relatively simple method of providing the insulating film 10. In this embodiment, especially, preferably this insulating film 10 is formed in the same semiconductor manufacturing process as that for the member 23, which constitutes the liquid chamber. That is, as mentioned above, the member 23 of the liquid chamber is comprised of a construction film made of an epoxy-based material formed in the predetermined pattern by photolithography, so that by changing this film forming pattern, the insulating film 10 can be formed of this construction film made of an epoxy-based material. By thus forming the insulating film 10, it is possible to eliminate the necessity of adding a new semiconductor manufacturing process for forming the insulating film 10 and with little increase in the manufacturing costs.

Note here that preferably the following connecting process is performed so that the bump 6 and the electric connecting terminal 15 may suitably be interconnected electrically with a suppressed contact resistance therebetween in such a contact state as mentioned above.

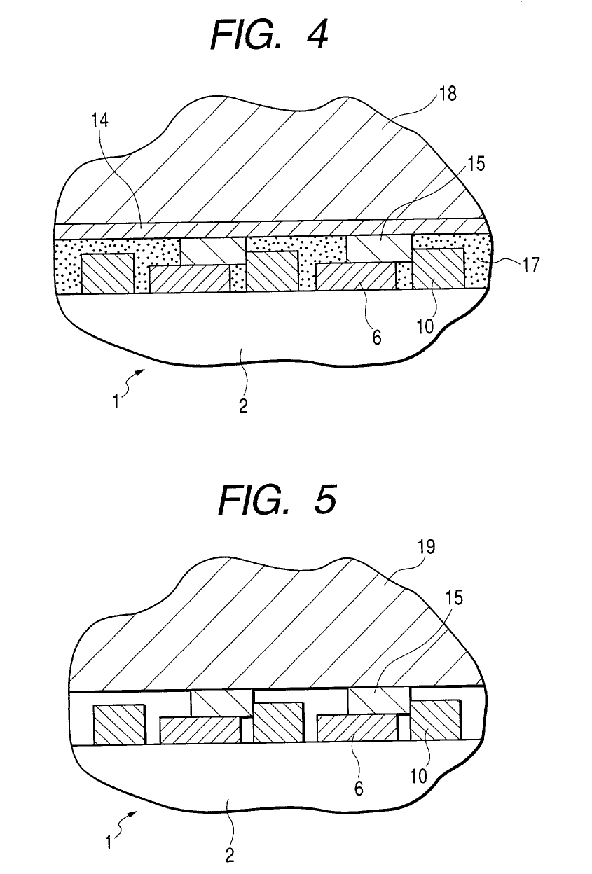

By one connecting method, as shown in FIG. 4, as the connecting material is used a thermo-hardening adhesive agent 17 mainly made of an epoxy-based resin, which is heated as applying a pressure across the bump 6 and the connecting terminal 15 in such a direction as to press them to each other thereby interconnect them. That is, this thermo-hardening adhesive agent 17 can be used to fill the gap between the electric wiring substrate 15 and the substrate 2 to then interconnect them as heating them with a heat tool 18 under pressure, thus electrically interconnecting suitably with a suppressed contact resistance therebetween. In this case, more preferably, as the thermo-hardening adhesive agent 17 is employed an anisotropic conductive adhesive agent containing conductive particles suitably fitted to high-density packaging. By another connecting method, as shown in FIG. 5, a gang bonding tool is used to heating them under pressure to interconnect them. This method is suitably fitted to a case of using as the electric wiring substrate 14 something in which at least the vicinity of the connecting section between itself and the bump 6 is made of TAB (Tape Automated Bonding) tape. By this method also, the connecting terminal 15 and the bump 6 can be electrically interconnected suitably.

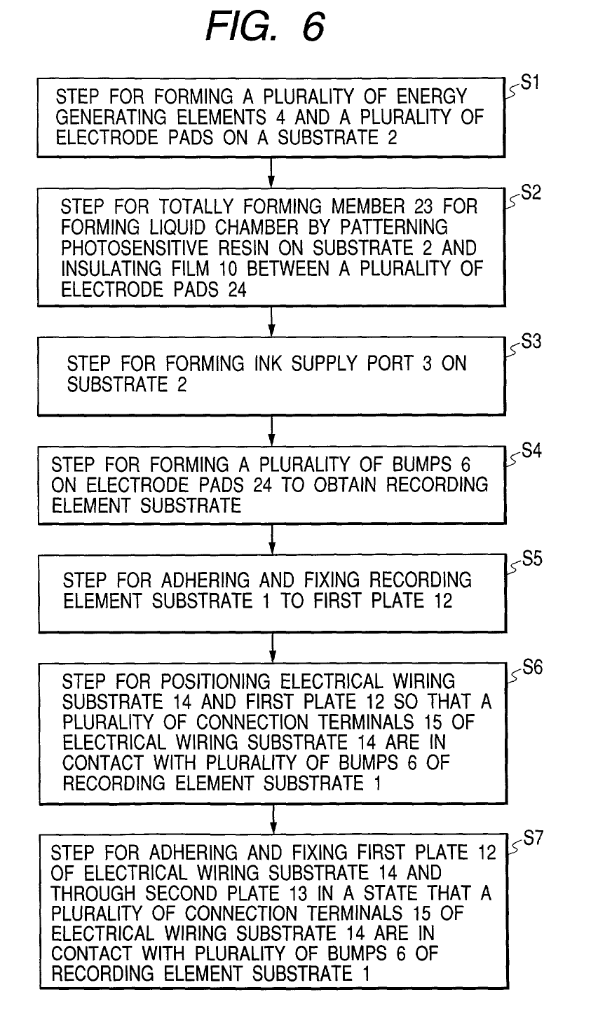

The recording element unit constituting an ink jet recording head of this embodiment mentioned above can be manufactured along the following process (see FIG. 6).

First, on the silicon substrate 2 are formed by patterning the electric thermal converter 4, the electrode pad 23, etc. using photolithography (S1). Then, as shown in FIG. 1, on thus patterned silicon substrate 2 is applied an epoxy-based photosensitive resin to form the member 23 for forming the liquid chamber into which liquid is supplied. In this case, in this semiconductor manufacturing process, the insulator film 10 is also formed of this photosensitive resin between each two of the electrode pads simultaneously (S2). Note here that the photosensitive resin according to this embodiment is formed to a thickness of, for example, 0.03 mm.

Next, anisotropic etching, sand blasting, etc. is used to form the ink supply outlet 3 of FIG. 1 in the silicon substrate 2 (S3). Further, on the electrode pad on the silicon substrate 2 is formed the plurality of bumps 6 of FIG. 1 in a row by, for example, forming a ball electrode (stud bump) by means of plating patterning or wire bonding (S4). Then, it is cut to form an external profile, thus obtaining a recording element substrate. Note here that in this embodiment the bump 6 is formed to a height of, for example, 0.02 mm.

Thus obtained recording element substrate 1 is adhered and fixed onto the first plate 12 at such a position thereof that the ink supply outlet 3′ is provided, using an adhesive resin (not shown) (S5).

Next, in a state where electric wiring substrate 14 is overlapped on said recording element substrate at a section thereof where each bump 6 is provided, each connecting terminal 15 of the electric wiring substrate 14 is positioned as fitted between each two of the insulating films 10 to be in contact with corresponding each bump 6 (S6), so that subsequently the surroundings of the joining section between each bump 6 and each connecting terminal 15 are filled with the thermo-hardening adhesive agent 17 or an anisotropic conductive adhesive agent 27 to interconnect each bump 6 and each connecting terminal 15 by adhesion by means of heating. Moreover, the electric wiring substrate 14 is adhered and fixed onto the first plate 12 via the second plate 13 having the opening 13a corresponding to the recording element substrate 1, using an adhesive agent (S7).

Note here that although the anisotropic conductive adhesive agent 17 is temporarily adhered or applied to the connecting terminal 15 beforehand when, as mentioned above, each connecting terminal 15 of the electric wiring substrate 14 and each bump 6 of the recording element substrate 1 are interconnected and adhered and fixed to each other, the present invention is not limited thereto; for example, the anisotropic conductive adhesive agent 17 may be temporarily adhered or applied to each bump 6 of the recording element substrate 1. Moreover, although the adhesive resin is temporarily adhered or applied to the side of the first plate 12, the present invention is not limited thereto; for example, it may be temporarily adhered or applied to the side of the electric wiring substrate 14.

Furthermore, the electric wiring substrate 14 of this embodiment may be comprised of a base film with a thickness of 0.025 mm and the connecting terminals 15 each having a thickness of 0.02 mm.

The above-mentioned steps are used to manufacture the recording element substrate unit of an ink jet recording head according to this embodiment.

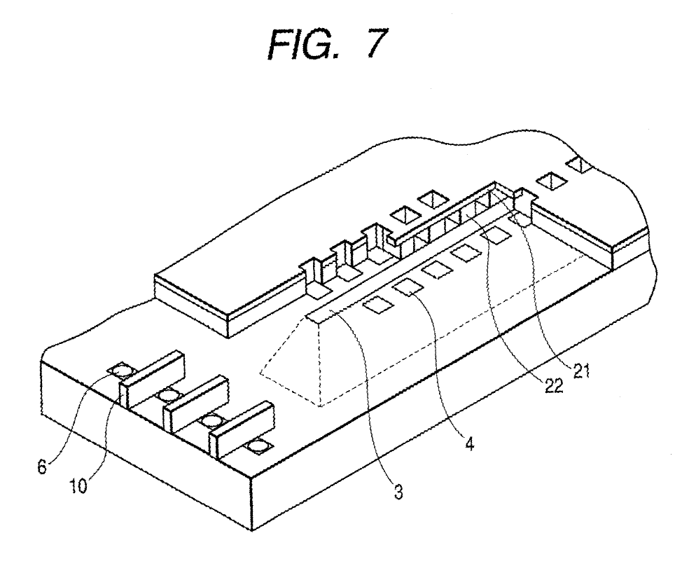

Further, also in a case where, as shown in FIG. 7, the liquid chamber formed on the above-mentioned recording element substrate 1 is comprised of an orifice member 21 having the discharge port 8 and a partition member 22 and the above-mentioned insulating film 10 is formed in the same semiconductor manufacturing process as the partition member 22, it is necessary to add a new semiconductor manufacturing process for forming the insulating film 10, thus increasing the manufacturing costs little.

Second Embodiment

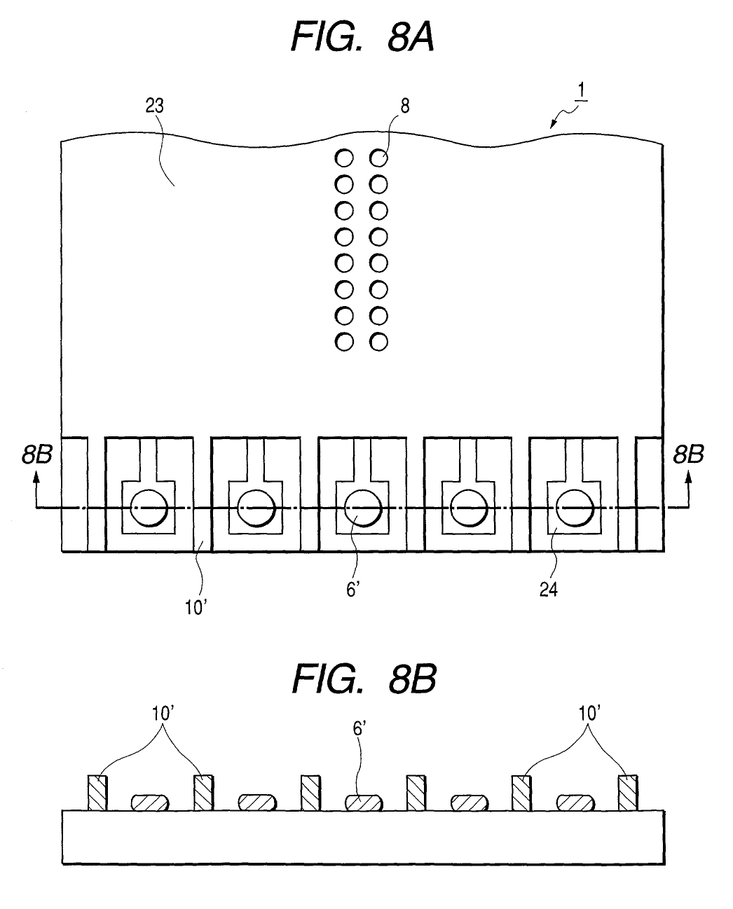

The following will describe the second embodiment of the present invention with reference to FIGS. 8A and 8B, and FIGS. 9 to 12. In this embodiment, the bump 6 is connected by single bonding by use of supersonic load with a connecting terminal 15′ consisting of such a portion of an inner lead as having been exposed in the opening 14a by partially removing the base film at the opening 14a formed in the electric wiring substrate 14. In this case, as shown in FIG. 12, for example, a single-point TAB tool 20 by Geizer can be used to electrically interconnect the connecting terminal 15′ and the bump 6′ suitably by using supersonic load. Moreover, in this embodiment, the insulating film 10 is formed of the material of the liquid chamber continuously therewith to be thereby formed integrally with the plurality of bumps 6 sandwiching it, thus improving the strength of the insulating film and also the joining strength between the insulator film and the recording element substrate as compared to the first embodiment. This in turn improves the yield and the connection reliability as compared to the first embodiment.

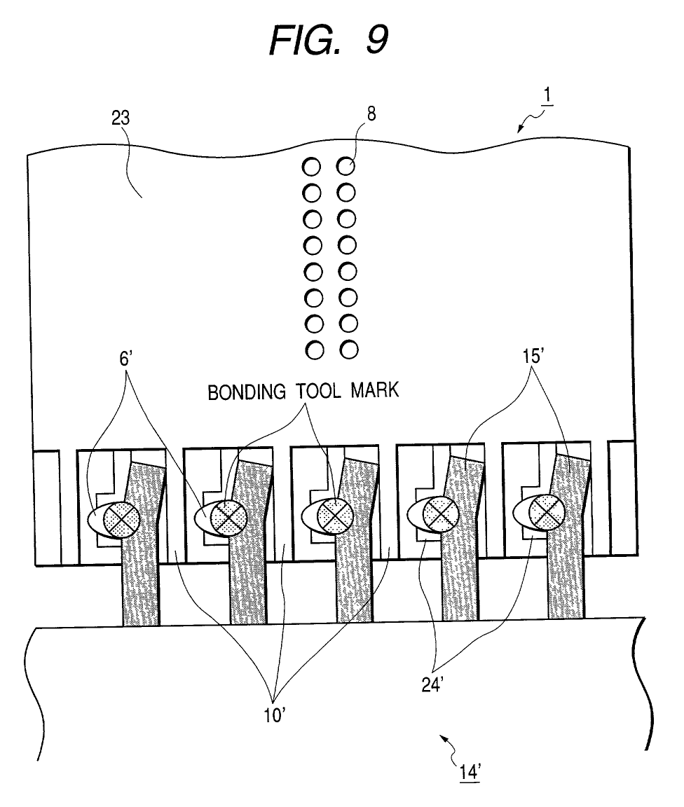

FIG. 8A is a top view for showing important parts of the recording element substrate and the electric wiring substrate before being interconnected according to the first example of this embodiment and FIG. 8B is a cross-sectional view taken along line 8B-8B of FIG. 8A. Moreover, FIG. 9 is a schematic top view for showing the important parts of the recording element substrate and the electric wiring substrate after being interconnected according to the first example. In the configuration of this example, even if a shift occurred between each stud bump 6 and each connecting terminal 15′ in positioning and, therefore, the load and supersonic wave vibration from the bonding tool caused the connecting terminal 15′ to be bent as sliding over the stud bump 6 in a direction of the shift or caused the stud bump to be crushed as widened in a direction opposite to that in which the connection terminal was bent, the deformation of the connecting terminal 15′ and the stud bump can be suppressed by the insulating film 10′ provided between the bump 6, thus preventing electrical short-circuiting effectively.

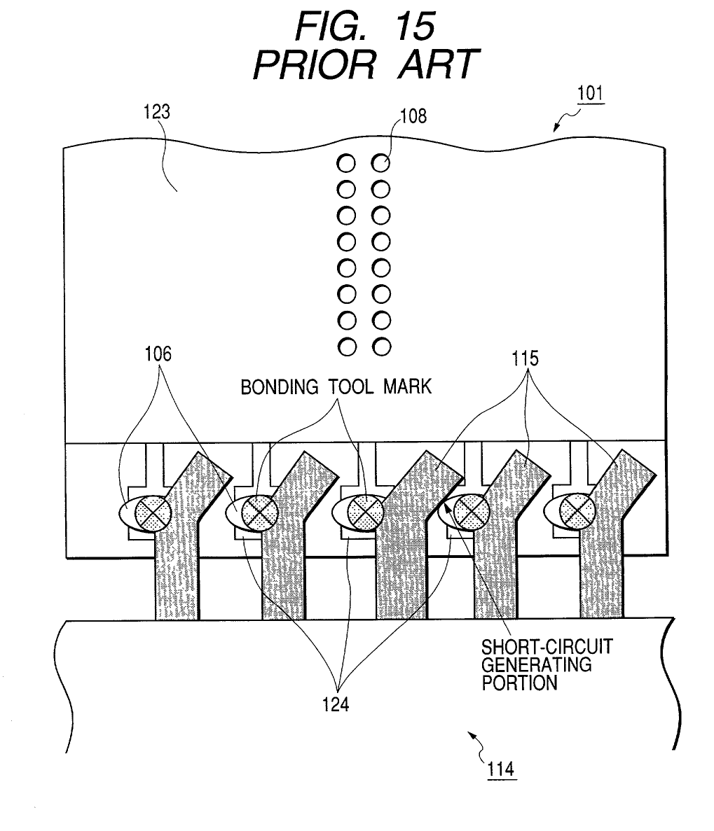

Conventionally, when a plurality of connecting terminals 115 provided on an electric wiring substrate 114 and a plurality of electrode pads and stud bump 106 provided on these electrode pads which are provided in parallel with each other on a recording element substrate 101 are positioned with respect to each other, the connecting terminal 115 are bonded as shifted in a direction in which said electrode pads are arrayed, which situation is shown in FIG. 15. As shown in FIG. 15, if the connection terminal 115 shifts in positioning with respect to the stud bump 6, the load and supersonic wave vibration given from the bonding tool causes the connecting terminal 115 to be connected sliding over the stud bump 106 as largely shifted in the direction of the shift of the connecting terminal 115 with respect to the stud bump 6, so that the connecting terminal 115 may in some cases come in electric contact with the adjacent connecting terminal 115 or the stud bump 106 in short-circuiting, thus breaking the recording head.

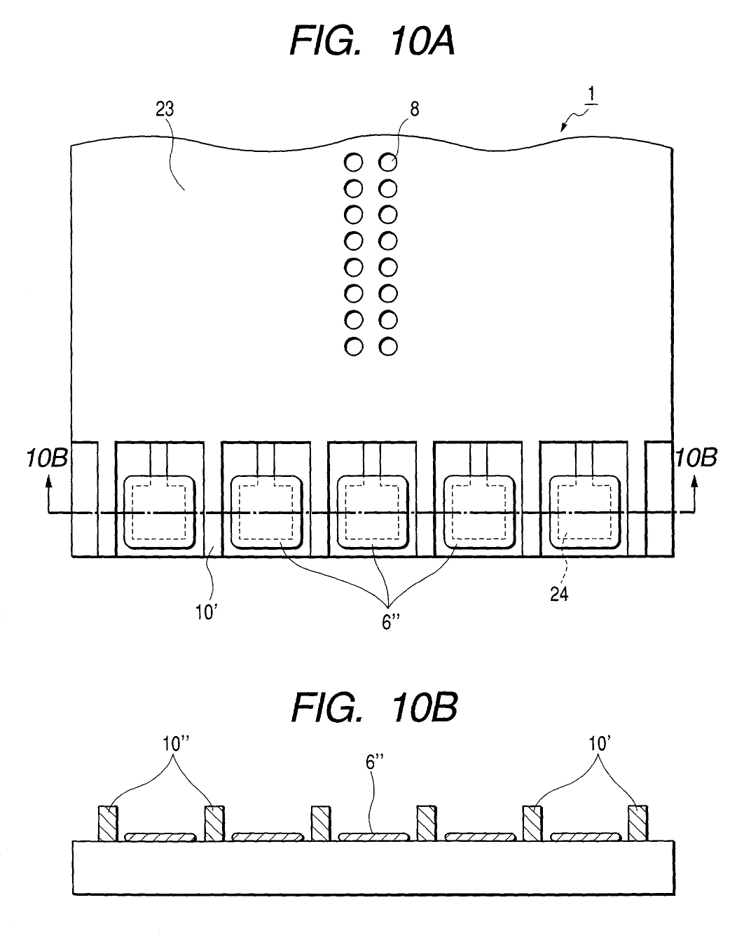

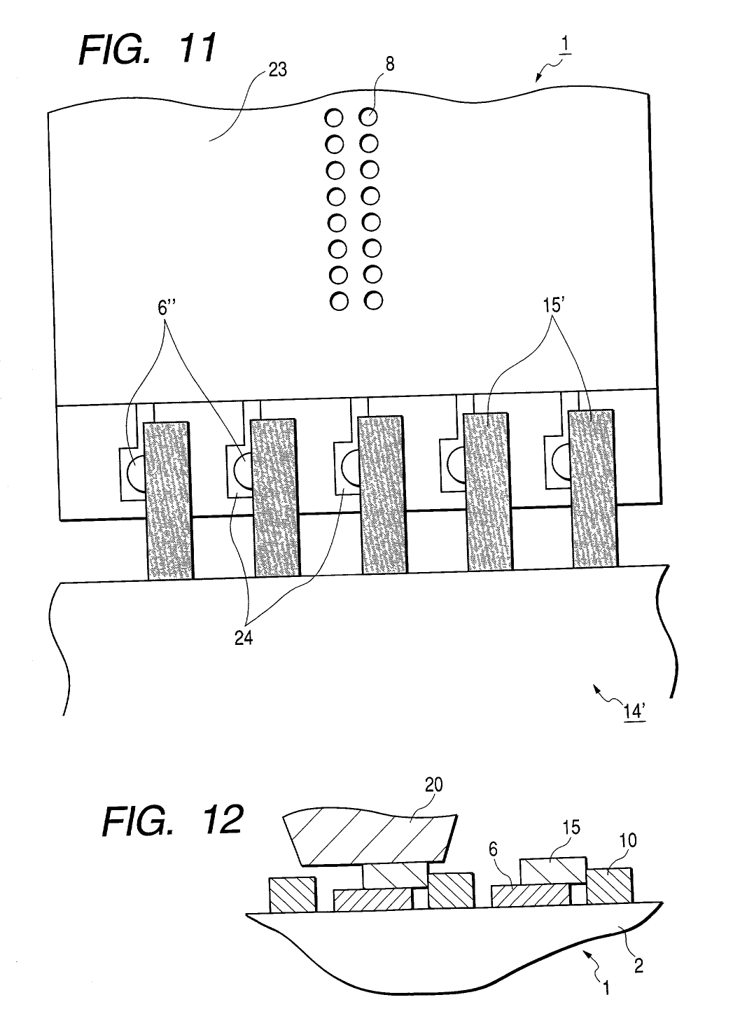

FIG. 10A is a top view for showing important parts of the recording element substrate and the electric wiring substrate before being interconnected according to a second example of this embodiment and FIG. 10B is a cross-sectional view taken along line 10B-10B of FIG. 10A. Moreover, FIG. 11 is a schematic top view for showing the important parts of the recording element substrate and the electric wiring substrate after being interconnected. In this example, a plated bump 6″ made of electroless nickel and electroless gold was connected with the connecting terminal 15′ of the electric wiring substrate 14′. This example features that the electrode pad provided on the recording element substrate and the connecting terminal 15′ provided on the electric wiring substrate are electrically interconnected via the plated bump 6″. The plated bump 6″ is better than the stud bump 6′ of the first example in height and flatness, thus giving such a configuration that a shift in positioning of the connecting terminal 115 may not be liable to give rise to sliding or extreme bump crushing.

Other Embodiments

The following will describe one example of a recording apparatus that can be mounted with the ink jet recording head according to any of the above-mentioned embodiments.

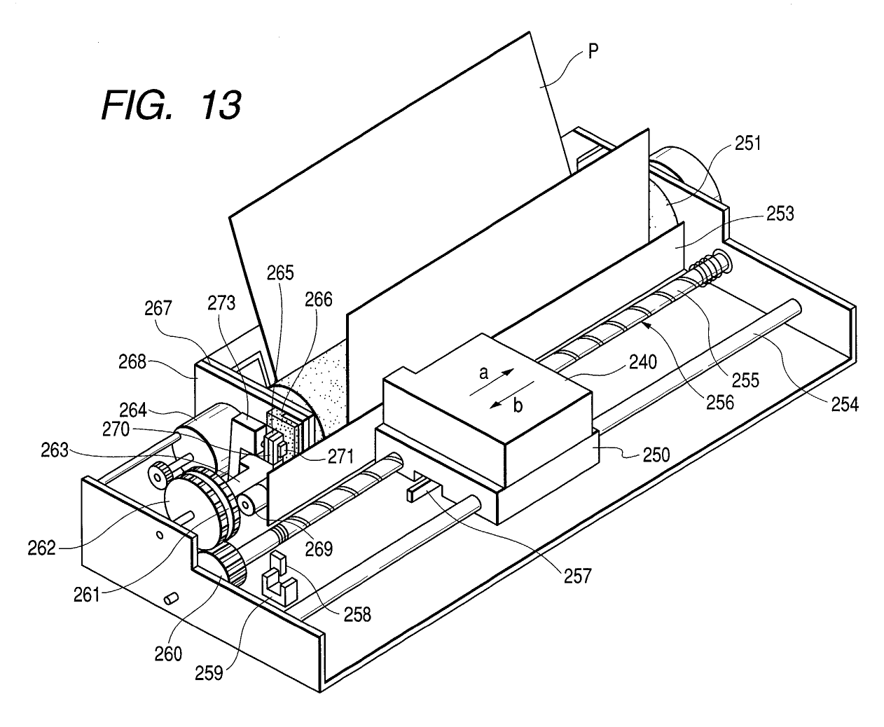

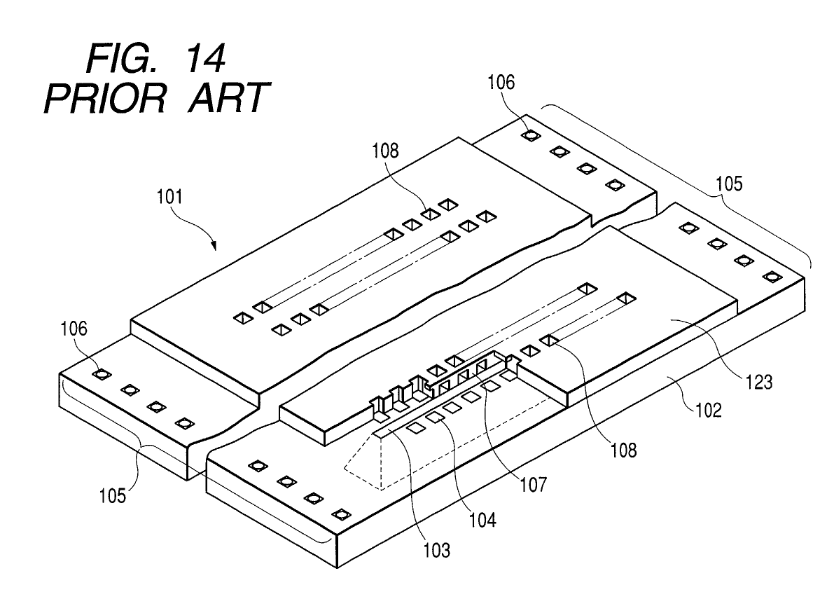

FIG. 13 is a perspective view for showing one configuration example of the recording apparatus of the present invention.

In FIG. 13, a lead screw 256 in which a spiral groove 255 is formed is interlocked with reverse/non-reverse rotation of a driving motor 264 to be driven in rotation via driving force transmitting gears 260 and 262.

A carriage 250 is engaged with the spiral groove 255 by a pin (not shown) and further guided along a guide rail 254 in a sliding manner, thus reciprocating in directions indicated by arrows a and b. This carriage 250 is mounted detachably with a ink jet cartridge 240 which is comprised integrally of an ink jet recording head having almost the same configuration as that indicated in the above-mentioned embodiments and a liquid reservoir for storing ink to be supplied to the ink jet recording head.

A paper pressure plate 253 presses a subject medium P against a platen roller 251 in a direction in which the carriage 250 moves.

Photo-couplers 258 and 259 constitute home-position detecting means for confirming the presence of a lever 257 of the carriage 250 in the region to reverse the rotation direction of the driving motor 264.

A cap member 270 for capping the front surface of the ink jet recording head is supported by a support member 265 and also provided with sucking means 273, to suck the ink jet recording head for recovery via an opening 271 formed in the cap.

A body support plate 267 has a support plate 268 attached thereto, so that a cleaning blade 266 supported by this support plate 268 in a sliding manner is moved back and forth by driving means not shown. The implementation of the cleaning blade 266 is not limited to that shown here but may take on any that is publicly known.

The lever 257 is used to start the operation of sucking for recovery, in such a manner that it starts moving when a cam 269 butting against the carriage 250 moves under the control of publicly known transmitting means such a gear 261 or a clutch when it transmits the driving force from the driving motor 264.

Each of these operations of capping, cleaning, and sucking for recovery is performed at corresponding each position by the action of the lead screw 256 when the carriage 250 has come to a home-position side region. Any desired one of these operations needs only to be performed at a known timing so that this example can be applied thereto.

What is claimed is:

1. An ink jet recording head comprising:
a liquid discharging substrate provided with both of a plurality of energy generating elements for generating energy utilized to discharge liquid from each of a plurality of ejection outlets in response to an electric signal and a plurality of connecting members electrically connected to said plurality of energy generating elements; and
an electric wiring substrate having a plurality of connecting terminals connected to said plurality of connecting members for transmitting an electric signal supplied from the outside to said plurality of energy generating elements, wherein:
said plurality of connecting members protrudes by a predetermined protrusion amount from said liquid discharging substrate;
said liquid discharging substrate has, between said plurality of connecting members, an insulating member comprised of at least one member protruding in the same direction as said plurality of connecting members; and
the protrusion amount of said insulating member is larger than the protrusion amount of said plurality of connecting members.

2. The ink jet recording head according to claim 1, wherein:
said plurality of connecting terminals protrudes by a predetermined protrusion amount in a direction opposite to said protrusion direction from said electric wiring substrate, in such a configuration that said electric wiring substrate overlaps such a portion of said liquid discharging substrate as having said plurality of connecting members formed thereon, to interconnect said plurality of connecting terminals and said plurality of connecting members; and
the protrusion amount of said insulating member with respect to said liquid discharging substrate is smaller than a total sum of the protrusion amount of said connecting members with respect to said liquid discharging substrate and the protrusion amount of said connecting terminals with respect to said electric wiring substrate.

3. The ink jet recording head according to claim 1, wherein:
on said liquid discharging substrate is formed a member constituting a liquid chamber in which said plurality of discharge ports is formed and which is filled with said liquid; and
said insulating member is made of the same material as the material of said member constituting said liquid chamber.

4. The ink jet recording head according to claim 1, wherein:
on said liquid discharging substrate is formed a liquid chamber filled with liquid that is constituted by an orifice member having said plurality of discharge ports formed therein and a partition member comprised of at least one member separating said plurality of energy generating element from each other; and
said insulating member is made of the same material as the material of said partition member.

5. The ink jet recording head according to claim 1, wherein said insulating member is formed integrally.

6. The ink jet recording head according to claim 2, wherein a gap between said liquid discharging substrate and said electric wiring substrate is filled with a thermo-hardening adhesive agent at surroundings of a connecting section between said connecting members and said connecting terminals.

7. The ink jet recording head according to claim 6, wherein said thermo-hardening adhesive agent is an anisotropic conductive adhesive agent containing conductive particles.

8. The ink jet recording head according to claim 2, wherein said connecting members and said connecting terminals are electrically interconnected by gang bonding, whereby said plurality of connecting members and said connecting terminals are collectively heated under pressure to be interconnected.

9. The ink jet recording head according to claim 1, wherein said connecting members and said connecting terminals are electrically interconnected by single-point bonding, whereby said plurality of connecting members and said connecting terminals are interconnected correspondingly by applying supersonic load.

10. An ink jet recording apparatus comprising:
the ink jet recording head according to any one of claims 1 to 9; and
a carriage for carrying said head.

11. An ink jet recording head manufacturing method comprising the steps of:
forming on a liquid discharging substrate a plurality of energy generating elements for generating energy utilized to discharge liquid from a discharge port in response to an electric signal;
forming on said liquid discharging substrate a plurality of electrode pads for connecting said plurality of energy generating elements to an external electric signal supply source;
forming, between said plurality of electrode pads on said liquid discharging substrate, an insulating member comprised of at least one member protruding by more than said predetermined protrusion amount in the same direction as the protrusion direction of said plurality of connecting members;
forming on said plurality of electrode pads a plurality of connecting members protruding from a surface of said liquid discharging substrate by a predetermined protrusion amount;
fitting each of said plurality of connecting terminals provided on an electric wiring substrate connected with said plurality of connecting members between each two of said insulating members so that said each connecting terminal and said each connecting member may come in contact with each other in order to transmit an electric signal supplied from the outside to said energy generating elements; and
fixing said liquid discharging substrate and said electric wiring substrate to each other at a position where said each connecting member and said each connecting terminal of said electric wiring substrate come in contact with each other.

12. The ink jet recording head manufacturing method according to claim 11, wherein:
in said ink jet recording head, said plurality of connecting terminals is formed to protrude from said electric wiring substrate in a direction opposite to said protrusion direction;
said electric wiring substrate is formed to cover said plurality of connecting members; and
the protrusion amount of said insulating member is smaller than a total sum of the protrusion amount of said connecting member and the protrusion amount of said connecting terminals with respect to said electric wiring substrate.

13. The ink jet recording head manufacturing method according to claim 11, comprising a step of integrally forming on said liquid discharging substrate a member in which said plurality of discharge ports is formed and which is filled with liquid and said insulating member.

14. The ink jet recording head manufacturing method according to claim 13, wherein said member constituting said liquid chamber and said insulating member are formed by a photolithographic technology performing the steps of:
forming a film made of a photo-sensitive material; and
exposing said film made of said photo-sensitive material to light through a predetermined pattern and etching said film to provide a predetermined planar shape.

15. The ink jet recording head manufacturing method according to claim 11, comprising the steps of:
collectively forming a plurality of partition members each comprised of at least one member for separating said plurality of energy generating elements from each other and said insulating member on said liquid discharging substrate; and
forming an orifice member in which said plurality of discharge ports is formed on said plurality of partition members.

16. The ink jet recording head manufacturing method according to claim 15, where said partition members and said insulating member are formed by a photolithographic technology for forming a predetermined construction film performing the steps of:
forming a film made of a photo-sensitive material; and
exposing said film made of said photo-sensitive material through a predetermined pattern and etching said film to provide a predetermined planar shape.

17. the ink jet recording head manufacturing method according to claim 12, comprising the steps of:
filling, with a thermo-hardening adhesive agent, a gap between said liquid discharging substrate and said electric wiring substrate at surroundings of a connecting section between said each connecting member and said each connecting terminal in a state where said liquid discharging substrate and said electric wiring substrate are arranged so that said each connecting member and said each connecting terminal may be in contact with each other; and
heating and hardening said thermo-hardening adhesive agent as applying a pressure across said liquid discharging substrate and said electric wiring substrate in such a direction as to press said each connecting member and said each connecting terminal to each other.

18. The ink jet recording head manufacturing method according to claim 17, wherein as said thermo-hardening adhesive agent is used an anisotropic conductive adhesive agent containing conductive particles.

19. The ink jet recording head manufacturing method according to claim 12, comprising a step of collectively interconnecting said plurality of connecting members and said plurality of connecting terminals in a state where said liquid discharging substrate and said electric wiring substrate are arranged so that said each connecting member and said each connecting terminal may be in contact with each other.

20. The ink jet recording head manufacturing method according to claim 11, comprising a step of individually interconnecting each of said plurality of connecting members and each of said plurality of connecting terminals in a state where said liquid discharging substrate and said electric wiring substrate are arranged so that said each connecting member and said each connecting terminal may be in contact with each other.
